(19) United States
(12) Patent Application Publication
(10) Pub. No.: US 2024/0177180 A1
(43) Pub. Date: May 30, 2024

(54) MACHINE LEARNING METHODS AND SYSTEMS FOR ASSESSING PRODUCT CONCEPTS

(71) Applicant: AI Palette Pte. Ltd., Singapore (SG)

(72) Inventors: Baruhupolage Don Kasun Sanjeewa Perera, Singapore (SG); Himanshu Upreti, Singapore (SG)

(21) Appl. No.: 18/284,635

(22) PCT Filed: Mar. 29, 2022
(86) PCT No.: PCT/SG2022/050171

§ 371 Date: Sep. 28, 2023

(30) Foreign Application Priority Data
Mar. 31, 2021 (SG) 10202103286T

(51) Int. Cl. G06Q 30/0202; G06Q 10/101

(52) U.S. Cl. CPC G06Q 30/0202; G06Q 10/101

(57) ABSTRACT

The present disclosure relates to systems and methods for assessing product concepts is provided. A method disclosed comprises: receiving a plurality of candidate product concepts, each candidate product concept comprising a natural language name and description of a candidate product; for each candidate product concept, extracting product ingredient data and product theme data, the product ingredient data indicating at least one product ingredient and the product theme data indicating at least one product theme; for each candidate product concept, determining a relevance metric using a market model, the market model comprising a machine learning model trained to provide relevance scores for product themes and product ingredients, and determining an originality metric using a cluster model; ranking the candidate product concepts in a ranking order according to the respective relevance metrics and originality metrics; and generating a ranked list of candidate product concepts according to the ranking order.

### CROSS-REFERENCE

The present application is a national stage entry of PCT/SG2022/050171, entitled “MACHINE LEARNING METHODS AND SYSTEMS FOR ASSESSING PRODUCT CONCEPTS,” filed on Mar. 29, 2022, which claims priority to SG Application No. 10202103286T, entitled “MACHINE LEARNING METHODS AND SYSTEMS FOR ASSESSING PRODUCT CONCEPTS,” filed on Mar. 31, 2021, each of which is incorporated herein by reference in its entirety for all purposes.

### TECHNICAL FIELD

The present disclosure relates to machine learning and in particular to the assessment of product concepts by simulating consumer responses to product concepts.

### BACKGROUND

In the fast-moving consumer goods (FMCG) market, new products are introduced often to meet the demands of consumers. In the current pace of changing consumer demands, FMCG companies struggle to develop new products as fast as demands are changing. The reason for this is, the traditional method of new product development is time consuming and error prone thus, making it difficult for FMCG companies to develop winning products that capture the consumers by meeting their requirements. On the other hand, developing new product concepts and testing those concepts against the consumer requirements is one of the early steps in new product development. This is a crucial step in the product innovation process since the chosen product concepts are the ones that will be realized in actual product development and will be released to the market. Thus, it is important to select product concepts that have the potential to address the consumer requirements, and in return generate significant revenue for the company. Such concepts may be called these “winning products”.

For any company in the FMCG sector to grow and be successful, it needs to continuously develop and introduce new products to the market based on changing consumer needs. This is quite evident for companies in the food and beverage industry (e.g. consumer packaged goods). The initial stage of this product innovation process is identifying what type of new products and/or new features to manufacture and bring to the market. This process traditionally involves market surveys to gather consumer requirements and focused group interviews to assess the acceptance of product concepts. The process typically starts by the FMCG company, decides the market's target group and conducts a market survey in the form of questionnaires with predefined answers (or occasionally open-ended questions). The questionnaire provides a list of questions intended to ascertain the features/qualities consumers may be interested in seeing in a new product. The inherent nature of this survey is it looks for answers from predefined questions thus be regarded as a “push” type survey. These types of surveys don't allow the consumer to create their own questions and answers reflecting an organic conversation. Questionnaire/Interview based market survey is biased towards the survey creator and doesn't help obtain raw, unbiased information from the consumer.

Another drawback of the conventional consumer survey is that the number of participants in a survey is typically limited even if the target consumer group consists of millions of consumers. This limited sample may not reflect the actual consumer needs in the larger population thus, making it hard for companies to develop new products that have a high demand from the consumers. Nevertheless, companies currently collect data from surveys and analyze them to find the consumer needs. Then the company's internal innovation team produces a set of product concepts to be evaluated by a panel of innovation and marketing executives. Prioritized product concepts then tested with an invited small group of consumers before deciding a small number of product concepts to launch.

### SUMMARY

According to a first aspect of the present disclosure, a machine learning method for assessing product concepts is provided. The method comprises: receiving a plurality of candidate product concepts, each candidate product concept comprising a natural language name and description of a candidate product; for each candidate product concept, extracting product ingredient data and product theme data, the product ingredient data indicating at least one product ingredient and the product theme data indicating at least one product theme; for each candidate product concept, determining a relevance metric using a market model, the market model comprising a machine learning model trained to provide relevance scores for product themes and product ingredients, and determining an originality metric using a cluster model; ranking the candidate product concepts in a ranking order according to the respective relevance metrics and originality metrics; and generating a ranked list of candidate product concepts according to the ranking order.

Embodiments of the present invention provide a new process to test product concepts against previously acquired consumer requirements (consumer needs). Particularly, this disclosure relates to a product concept testing directed to elicit, unknown, unmet or high in demand needs of a consumer group using, an aspect of the invention, agent-based learning and simulation in the idea discovery stage of the FMCG product innovation process. New product development has two crucial steps in the FMCG product innovation cycle. They are generating new product concepts and validating/testing these concepts to select the winning concept. A winning concept is a description of the product where it meets the requirements of the consumers in a conceptual manner.

The new product concepts are ranked based on two qualities namely Relevance and Originality. Relevance indicates the similarity between claims mentioned in the product concepts and the consumer needs captured through the online AI and analytical tool foresight engine. This foresight engine simply produces a weighted consumer needs and ingredient trends from a targeted consumer group (e.g. Snacks consumers in Thailand). Originality assess the uniqueness of the given product concept against all the retail products currently available to the given consumer group.

In an embodiment, extracting product ingredient data and product theme data, comprises using an embedding model and a recognition model.

In an embodiment, the embedding model comprises mappings from a plurality of languages.

In an embodiment, determining a relevance metric using a market model for each candidate product concept comprises: simulating a consumer response to each respective candidate product concept using a plurality of simulated agents which are configured to update the market model and thereby obtain a respective simulated market model for the respective candidate product concept, and determining the respective relevance metric from the respective simulated market model for the candidate product concept.

In order to assess the success probability of a product concept we use above mentioned metrics in a simulated environment where we simulate the acceptance of the concept by consumers. Consumer behavior is mapped with already extracted “consumer need information” and runs with multi-agent based modeling (with >10000) participants.

In an embodiment, simulating the consumer response to the candidate product using a plurality of simulated agents comprises simulating interactions between simulated agents over a plurality of simulation cycles, wherein simulated agents of the plurality of simulated agents are configured to be connected to other connected simulated agents of the plurality of simulated agents and thereby influence behavior of the connected simulated agents.

In an embodiment, a first simulated agent of the plurality of simulated agents has a higher number of connections than a second simulated agent of the plurality of simulated agents.

According to a second aspect of the present disclosure, a method of training a market model to provide relevance scores for product themes and product ingredients is provided. The method comprises: monitoring social network posts to collect data; extracting product ingredient data and product theme data from the collected data; training a recognition engine using the collected data to recognize ingredients and product themes from the collected data; and training a market model based on the ingredients and the product themes.

In an embodiment, monitoring social network posts to collect data comprises implementing a plurality of market sensors.

In an embodiment, the collected data comprises text data and image data and wherein extracting product ingredient and product theme data from the collected data comprises implementing a joint text and image embedding layer.

In an embodiment, extracting product ingredient and product theme data from the collected data comprises implementing a multi-lingual embedding layer.

According to a third aspect of the present disclosure, a computer readable medium storing processor executable instructions which when executed on a processor cause the processor to carry out a method set out above.

According to a fourth aspect of the present disclosure, a machine learning system for assessing product concepts is provided. The system comprises: a processor; a data storage device storing: a market model comprising a machine learning model trained to provide relevance scores for product themes and product ingredients; and a cluster model; and a program storage device storing computer program instructions operable to cause the processor to: receive a plurality of candidate product concepts, each candidate product concept comprising a natural language name and description of a candidate product; for each candidate product concept, extract product ingredient data and product theme data, the product ingredient data indicating at least one product ingredient and the product theme data indicating at least one product theme; for each candidate product concept, determining a relevance metric using the market model, and determine an originality metric using the cluster model; rank the candidate product concepts in a ranking order according to the respective relevance metrics and originality metrics; and generate a ranked list of candidate product concepts according to the ranking order.

In an embodiment, the program storage device further stores computer program instructions operable to cause the processor to extract product ingredient data and product theme data using an embedding model and a recognition model.

In an embodiment, the embedding model comprises mappings from a plurality of languages.

In an embodiment, the program storage device further stores computer program instructions operable to cause the processor to determine a relevance metric using a market model for each candidate product concept by simulating a consumer response to each respective candidate product concept using a plurality of simulated agents which are configured to update the market model and thereby obtain a respective simulated market model for the respective candidate product concept, and determining the respective relevance metric from the respective simulated market model for the candidate product concept.

In an embodiment, the program storage device further stores computer program instructions operable to cause the processor to simulate the consumer response to the candidate product using a plurality of simulated agents by simulating interactions between simulated agents over a plurality of simulation cycles, wherein simulated agents of the plurality of simulated agents are configured to be connected to other connected simulated agents of the plurality of simulated agents and thereby influence behavior of the connected simulated agents.

In an embodiment, the program storage device further stores computer program instructions operable to cause the processor to train the market model to provide relevance scores for product themes and product ingredients by: monitoring social network posts to collect data; extracting product ingredient data and product theme data from the collected data; training a recognition engine using the collected data to recognize ingredients and product themes from the collected data; and training a market model based on the ingredients and the product themes.

In an embodiment, the program storage device further stores computer program instructions operable to cause the processor to monitor social network posts to collect data by implementing a plurality of market sensors.

In an embodiment, the collected data comprises text data and image data and wherein the program storage device further stores computer program instructions operable to cause the processor to extract product ingredient and product theme data from the collected data by implementing a joint text and image embedding layer.

In an embodiment, the program storage device further stores computer program instructions operable to cause the processor to extract product ingredient and product theme data from the collected data by implementing a multi-lingual embedding layer.

### BRIEF DESCRIPTION OF THE DRAWINGS

In the following, embodiments of the present invention will be described as non-limiting examples with reference to the accompanying drawings in which:

FIG. 1 is a block diagram showing a product concept assessment system according to an embodiment of the present invention;

FIG. 2 is a flow chart showing a method of assessing product concepts according to an embodiment of the present invention;

FIG. 3 is a flow chart showing extraction of information from a candidate product concept in an embodiment of the present invention;

FIG. 4 is a flow chart showing a method of training a market model according to an embodiment of the present invention;

FIG. 5 shows a multilingual embedding model according to an embodiment of the present invention;

FIG. 6 is a flow chart showing joint embedding method according to an embodiment of the present invention;

FIG. 7 is a flow chart showing training of a market model according to an embodiment of the present invention; and

FIG. 8 is shows updating of a market model by an agent according to an embodiment of the present invention.

### DETAILED DESCRIPTION

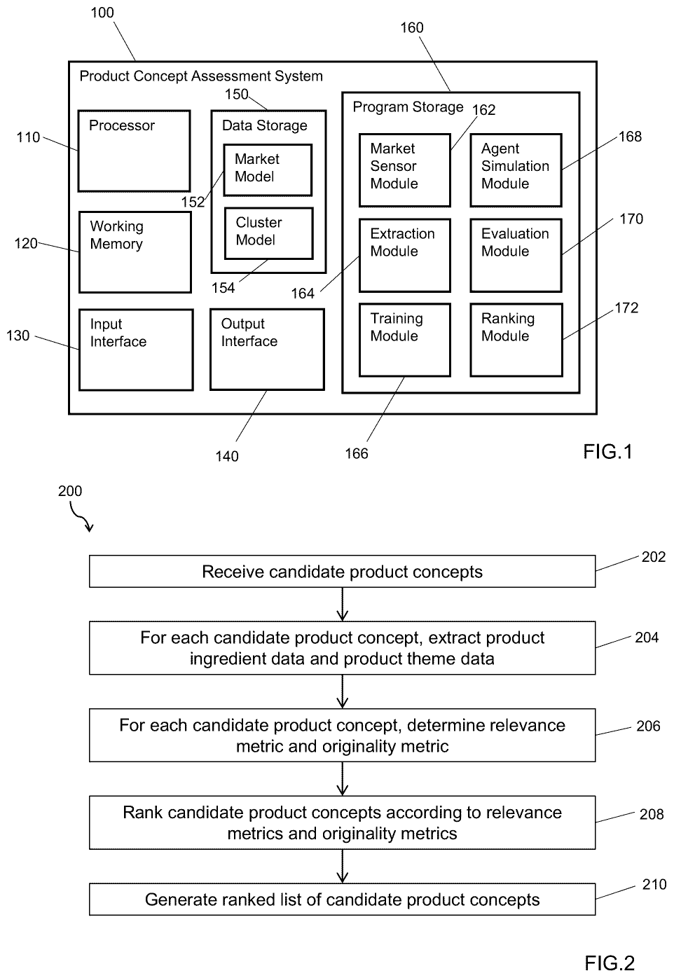

FIG. 1 is a block diagram showing a product concept assessment system according to an embodiment of the present invention. The product concept assessment system 100 is a computer system with memory that stores computer program modules which implement machine learning product concept assessment methods according to embodiments of the present invention.

The product concept assessment system 100 comprises a processor 110, a working memory 120, an input interface 130, an output interface 140, data storage 150 and program storage 160. The processor 110 may be implemented as one or more central processing unit (CPU) chips. The program storage 160 is a non-volatile storage device such as a hard disk drive which stores computer program modules. The computer program modules are loaded into the working memory 120 for execution by the processor 110. The input interface 130 is an interface which allows data including indications of candidate product concepts, and setting for assessment of product concepts to be received by the product concept assessment system 100. The output interface 140 is coupled to an output device which allows the result of the assessment of product concepts such as a ranked list of candidate product concepts to be output. The output interface 140 may be coupled to display device or a printer.

The data storage 150 stores a market model 152 which is trained to simulate market responses to candidate product concepts and a cluster model 154 which maps existing products onto a vector space in order to provide an originality metric for candidate product concepts.

The program storage 160 stores a market sensor module 162, an extraction module 164, a training module 166, an agent simulation module 168, an evaluation module 170, and a ranking module 172. The computer program modules cause the processor 110 to execute product concept analysis processing which is described in more detail below. The program storage 160 may be referred to in some contexts as computer readable storage media and/or non-transitory computer readable media. As depicted in FIG. 1, the computer program modules are distinct modules which perform respective functions implemented by the product concept assessment system 100. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the computer program modules is described herein, these may alternatively be implemented as one or more hardware modules (such as field-programmable gate array(s) or application-specific integrated circuit(s)) comprising circuitry which implements equivalent functionality to that implemented in software.

FIG. 2 is a flow chart showing a method of assessing product concepts according to an embodiment of the present invention. The method 200 shown in FIG. 2 is carried out by the product concept assessment system 100 shown in FIG. 1.

In step 202, the input interface 130 of the product concept analysis system 100 receives candidate product concepts. The candidate product concepts comprise text data indicating a natural language name and description of a candidate product.

In order to assess the candidate product concepts that could work in the market, the user, for example a consumer-packaged goods (CPG) company creates multiple product concepts. Usually this ranges from 10-20 depending on the application, market, the defined audience etc. The product concept is none other than a name and description of a product.

In step 204, for each candidate product concept, the extraction module 164 is executed by the processor 110 of the product concept analysis system 100 to extract product ingredient data and product theme data from the candidate product concept.

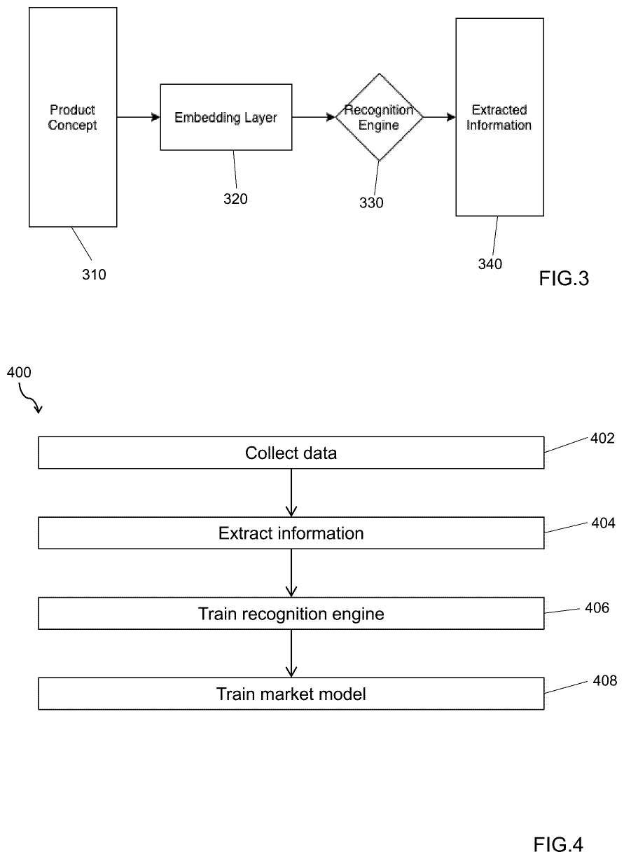

FIG. 3 is a flow chart showing extraction of information from a candidate product concept in an embodiment of the present invention. The processing illustrated in FIG. 3 may be carried out during step 204 of the method 200 shown in FIG. 2. Once the user creates multiple product concepts, in the analysis, they can enter those product concepts as a batch and consider each product concept as an individual entity and pass through an information recognition engine to extract the information from each product concept.

As shown in FIG. 3, the input to the processing is the product concept 310 which comprises a natural language text description. In some embodiments, this natural language text description may be in one or more of a plurality of language and the processing may identify the language(s) and this information may be considered in the later processing.

The product concept 310 is input into an embedding layer 320. The embedding layer 320 maps onto a recognition engine 330 which recognizes ingredients and themes in the product concept 310 and output the extracted information 340 which comprises ingredient data and product theme data.

The implementation of the embedding layer 320 and the recognition engine 330 are discussed in more detail below.

Returning now to FIG. 2, in step 206, the evaluation module 170 is executed by the processor 110 of the product concept assessment system 100 to determine a relevance metric and an originality metric for the product concept. From a given set of product concepts, it is important to rank them based on the probability of success such that businesses can focus more on the products that have a higher chance of success.

But to do that, these product concepts need to be evaluated based on the certain matrices that reflect the market acceptance. Thus, in certain metrics are introduced to reflect the success probability in the target market.

The relevance metric is determined using the market model 152 stored in the data storage 152. The relevance metric defines how relevant a product concept is to the market. The relevance is defined by how many consumers prefer the product concept (or what it contains as ingredients or themes). This relevance is measured against consumer engagement, rate of change of the engagement, existing retail/food service products, and prediction of the engagement for next 6 months. The relevance is calculated for ingredient(s) and theme(s) separately and finally combined as follows.

The relevance score attempts to quantify the demand for a particular product based on the ingredients and themes which are tagged to that product. The relevance score ranges from 0-100 and the scoring does not depend on the other products which are being screened.

In this process, each ingredient and each theme is given a relevance score. This relevance score will be based on the trend classification and then the relative ranking of the ingredient/theme within that classification.

| Classification | Scores |
|---|---|
| Growing, Matured | 51-100 |
| Emerging, Dormant | 21-50 |
| Declining, Fading | 0-20 |

Firstly, the ingredients are separated into different buckets based on their classification. Next, the ingredients will be ranked within each bucket based on the 2 Year Growth Coefficient and 4 Year Total Growth. Finally, the ingredient and themes will be assigned a relevance score by scaling the rank to the range of scores in the bucket.

To assign the final relevance score to the product concepts, we take the average of the ingredient scores and the average of the theme scores and use the formula:

Total Score=0.4×Ingredient Mean Score+0.6×Theme Mean Score.

The final total score gives the relevance metric for the candidate product concept.

The originality metric indicates how innovative and novel a particular product is by comparing it with other products that are already present in the market. The more products in the market that are similar, the less original the product is. For each product an originality score of 0-100 is assigned based and this scoring will depend on the other products which are being screened. For originality, two approaches are being considered.

A natural language processing (NLP) algorithm Word2Vec is used to learn about the tagged components in a product concept similar to how we approach words in a sentence. NLP algorithms learn about language by trying to predict the next word in a sentence. If the model is able to do this well, it is able to understand the rough structure and semantics of the sentence. Likewise, the cluster model 154 is trained by trying to predict what ingredients/themes are in a particular product given other ingredients/themes.

Once the cluster model 154 is trained we can map all products to a vector space and perform clustering to identify the number of products that are close. The list will be sorted by the number of similar products which will then be used for the final originality score

The skipgram implementation of word2vec uses an ingredient/theme to predict 4 other ingredient/themes in the product concept and is trained as a classification problem. The training procedure for this is as follows:
1. Convert the ingredient/themes to an index
2. For each n-sized list of different ingredient/themes, iterate through the list to pick
   a. i-th item which will be the input item
   b. Sample of 4 other items which will be the target.

In some embodiments, the market model 152 is modified by simulating consumer and influencer responses to the product concepts on social media. This agent-based simulation is described in more detail below.

In step 208, the ranking module 172 is executed by the processor 110 of the product concept assessment system 100 to rank the product concepts according to the metrics calculated in step 206.

In step 210, the ranking module 172 is executed by the processor 110 of the product concept assessment system 100 to generate a ranked list based on the ranking calculated in step 208. This ranking may be output to a user by the output interface 140.

FIG. 4 is a flow chart showing a method of training a market model according to an embodiment of the present invention. The method 400 shown in FIG. 4 is carried out by the product assessment system 100 shown in FIG. 1 to train the market model 152 stored in the data storage 150.

In order to evaluate market behavior, a wide range of data is collected such as social media (Weibo, twitter, instagram etc), blogs and forums (Pantip, The Peach Kitchen, Mouthshut etc), e-Commerce platforms (Lazada, Amazon, JD etc), recipe databases (NDTV food, Pepper.ph etc), restaurant reviews (Zomato, Meituan etc).

In order to assess the market in changing consumer behavior, historical data dating back to 2014 is collected and data may be continuously collected in weekly intervals to get the most up to date market information. Multiple approaches may be employed to collect this data depending on the source and the complexity. For example, the following approaches may be used.
1. Headless browser+Selenium
2. APIs
3. Proxy based scraper bots

In step 402, the market sensor module 162 is executed by the processor 110 to collect data. The data may be collected by market sensors. Virtual market sensors may be defined that act similar to physical sensors in any simulation environment. These market sensors have the ability to precisely measure the changes in the market. These sensors act as receptors to agents in the simulation environment. Agent's actions within the simulation environment is determined by the inputs of these sensors and the algorithm defined in the present disclosure to mimic the actual consumer behavior.

A virtual sensor, referred to as “Ingredient Engagement” is used to sense and measure the popularity of a particular ingredient in the market. The engagement is calculated using the following formula for any given market. We assume that there is a fixed set of data sources to be considered for a given market. Each of these sources (social data) has posts and their respective likes, comments and shares. The different sources may use different names to specify likes, comments and shares but they essentially behave the same way.

The engagement of a specific post may be defined as:

ESp=1+A(Likes)+B(Comments)+C(Shares)

where A, B and C are weights assigned to each type of engagement.

The total engagement of an ingredient is then defined as:

ESt=A(ESp1)+B(ESp2)+C(ESp3)

where A, B and C are weights assigned to each platform and determined by A=((A+B+C)/A), B=((A+B+C)/B) and so on.

Product themes are also measured and fed as an input to the agents in the simulation. The preferences of consumers towards product themes is reflected through consumer need engagement score which is calculated in the same way as ingredient engagement score.

Another market sensor is the search trend collection. We employ this market sensor to capture the search trend information pertaining to the entities identified and used in the Ingredients and product theme market sensors. What it means is through named-entity recognition (NER) we identify an entity such as (Apple, Ingredient) and (Tasty, product theme) and we employ our ingredient market sensor to capture the engagement for Apple among the consumers. We also use consumer need market sensors to fetch engagement on tasty as a product theme. With search trend sensors, we use these terms as indicators to fetch meta information related to search trends for ingredients and product themes.

Summary of the sensors are:
1. Ingredient social data sensor
2. Theme social data sensor
3. Ingredient search data sensor
4. Theme search data sensor

We have multiple sensors to track the following trends from the UGC (User Generated Content) available on various platforms. Platform here could be social media, recipe, cafe, review, e-commerce, blog, forum, etc.
1. Ingredient
2. Theme
3. Product
4. Consumer Need
5. Sub Consumer Need
6. Consumer Need Category
7. Subcategory

The Sensors are specific to a trend and a platform and are triggered at the end of every day to capture the consumer conversations related to the trend from the respective platform. In addition to capturing the conversation, these Sensors also do the enriching of the data collected in terms of language, engagement score, sentiment score, etc.

Also, whenever a new consumer platform is added, the aforementioned Seven Sensors have to be built to capture the information from that platform.

For example, if the ingredient trend is “Apple” and the platform is Twitter, then the Ingredient sensor will go and collect all the relevant data for Apple as a food ingredient from the Twitter Platform at the end of every day. Similarly, if the theme trend is “Home Cooking” and the platform is Facebook, then the Theme sensor will collect all the data pertaining to homemade recipes and cooking techniques from the Facebook platform.

Every Sensor is composed of a workflow and the workflow is managed via Airflow, an open source workflow management platform. Airflow allows us to execute workflows as Directed Acyclic Graphs (DAGs) of tasks. Every DAG can have one or more tasks which are scheduled to be run by the Airflow Master/Scheduler and are pushed to the message broker (RabbitMQ) sequentially for executions. Airflow workers, which scale automatically depending on the load, pick up these tasks.

To elaborate on how the consumer conversation ties up with the Sensors, the following example is provided. If the consumer conversation on Twitter has the text as “Loved the Brown Matcha Latte for its health and immunity benefits” the following sensors at the end of the day will get triggered off to collect this post.
Ingredient Sensor—Matcha
Theme Sensor—Health
Product Sensor—Brown Matcha Latte
Consumer Need Sensor—Taste
Sub Consumer Need Sensor—Immunity
Consumer Need Category Sensor—Driver
Subcategory Sensor—Coffee

These sensors analyze the consumer conversation text and then enrich them with the fields such as sentiment positive, engagement score 1.5, language English.

In step 404, the extraction module 164 is executed by the processor 110 to extract information from the data collected in step 402.

In step 406, the training module 166 is executed by the processor 110 to train the recognition engine 330. In order to process the analytical information, three main types of information are extracted:
1. Ingredients
2. Consumer Needs as a Theme
3. Sub categories

Ingredients are the main contents of any food product and can range from main content, flavor additives, texture additives etc. For example, a vanilla cappuccino is a food item and consists of coffee, vanilla and milk as the ingredients. In this particular food item, vanilla has been added as a flavor ingredient while milk and coffee are main content ingredients.

Consumer needs are the reasons why a consumer uses such a food item and he/she mentions that reason in his/her online presence. For example, assume the online mention of this vanilla cappuccino as “This new vanilla cappuccino from X-cafe is so creamy and tasty with a nice smell to it”. In this online text, we can see “creamy”, “tasty” and “nice smell” as three main benefits/drivers which we consider as consumer needs. These can be ranging from drivers, barriers, product attributes, pairings, target consumer and product formats. In order to understand these consumer needs in detail we extract more finer information through sub consumer needs which is a collection of information to group into a consumer need. One such example is Health as a consumer need but healthy, immunity, blood sugar, blood pressure are some examples sub consumer needs that fall under health as a consumer need.

The third type of information extracted is the sub category types the respective food is being consumed. We broadly categories food into Beverages, Snacks, Confectionaries, Meals etc. In each of these categories we can define a set of sub categories. For example, in Beverage, we can identify Juice, Coffee, Tea, Energy Drinks etc. For each sub category there could be further sub-sub categories such as in the Coffee sub category there can be americano, cappuccino, latte, flat white etc. In order to assess the consumer behavior in the market with greater details we need to identify such sub categories and sub-sub categories.

When preparing the data for extraction we employ image and text embedding and text with emoji embedding as inputs to the named-entity recognition (NER) model. We introduce a new text and image embedding technique that is superior in identifying food related insights from both images and text. The objective of this embedding is to identify food concepts such as ingredients, food products, consumer needs in an efficient way closer to human recognition.

Previous joint embedding techniques use term frequency-inverse document frequency (tf-idf) and bag of words (BOW) as text embedding mechanisms as most cases actually use images with their tags as embeddings. The objective of previous approaches is to retrieve best matching tags from a given image or vice versa.

In the present disclosure, we use Word2Vec for text embedding as it encompasses semantic dependency of the token in the associated text sentences. Combined with image embedding through convolutional neural networks, the final embedding is a rich representation of a social document which is a genuine organic expression of a consumer behavior.

A modified word2vec model is used to embed the social data which could comprise multiple languages and emojis. One drawback is that Word2Vec requires new embedding matrices for scaling in new languages. A new embedding matrix is developed that works for social data on food related content that can handle multiple languages through a single model.

Initially, a multilingual tokenizer is trained to process the text data. A large dictionary extracted from massive social media text data is maintained and updated with new data feed into the system constantly. For example, if users are discussing a newly created snack on the social media platform, new terms and emojis related to food will be detected and added to the dictionary. Then the model is able to capture these terms. After tokenization is done, the data is passed to the embedding layer. In this embedding, public word embedding trained from large text corpus are combined with the food related social data. And then evaluated by the NER task for further optimization. Thus, it has a specificity of FCMG food domain and outperforms the generic embeddings.

Our goal is to build a single embedding space for N arbitrary languages that are in our corpus. We demonstrate the capability of generating a single embedding space for English, Chinese, Thai, German and Bahasa (Indonesia, Malaysia) languages. Selection of these languages is due to our focus on Asian and European markets while demonstrating the cross-language dependencies in Asian and European languages.

We propose a completely unsupervised multilingual word embedding technique and to support that we have built a large corpus with English (10B+ words), Chinese (10B+ words), Thai (1B+ words), German (4B+ words), Italian (2B+ words), French (6B+words) and Bahasa (5B+ words). To start with the implementation for multilingual embedding, we assume that we have monolingual embedding of each of the languages in our corpora.

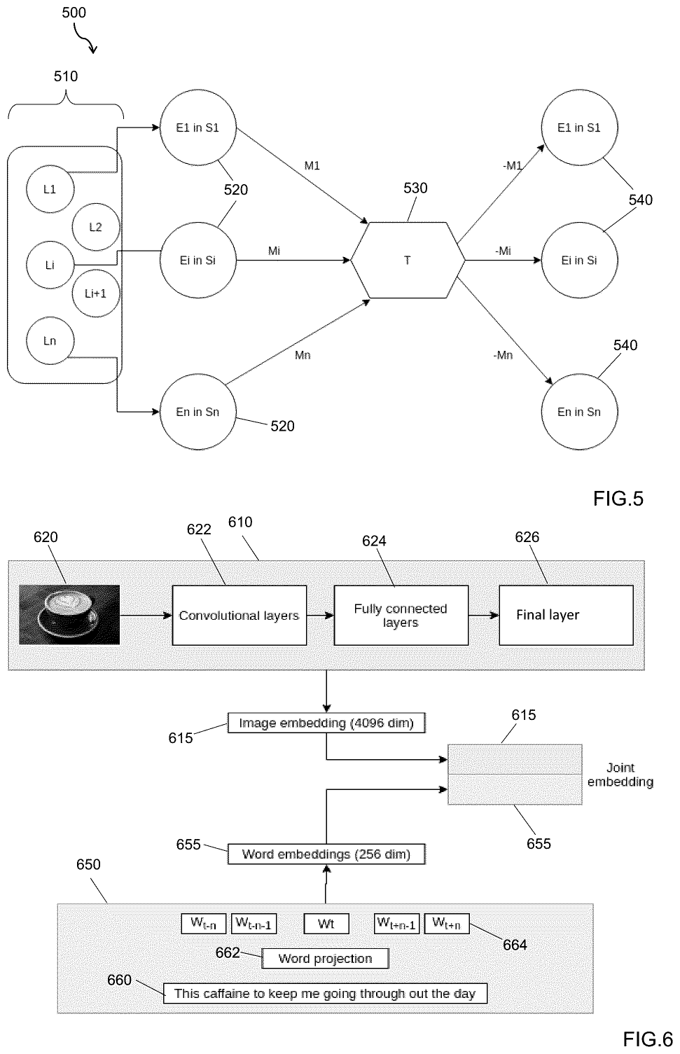

FIG. 5 shows a multilingual embedding model according to an embodiment of the present invention. The embedding model 500 has n languages 510 and maps each language Lionto embedding space Eᵢ in the respective embedding space Sᵢ 520. Each Eᵢ in Sᵢ 520 is mapped to a target space 530 (target language) T using encodes Mᵢ. Decoder −Mᵢ will decode the embeddings in target space T 530 to original space Sᵢ 540. We maintain these linear mappings as orthogonal such that −Mᵢ=transpose(Mᵢ). As we have n languages (including English), we do not have to map every language to a hypothetical space of T, we have mapped every other language to English as the target space. The reason for this is that, in our empirical analysis, we have found social media posts often contain mixed languages of native and English. The reason for this is that food related information is often influenced by other regions thus, consumers tend to use native language with English language to express their views on social media.

Our algorithm works as follows:

```
Repeat until convergence :
  M - encoding iterations
  For each language Lᵢ
    Sample a word set wᵢ
    \hat{ }Wₜ = Mᵢ(wᵢ)
    \hat{ }Wⱼ = transpose(Mⱼ)(\hat{ }Wₜ)
    \hat{ }yⱼ = Dⱼ(\hat{ }Wⱼ)
    Loss = loss + L_{d}(1,\hat{ }y)
  Update Mᵢ parameters to minimize loss
  D - discriminator
  Lossd = 0
  For each language Lⱼ
    Sample a word set wᵢ
    Sample a word set wⱼ
    \hat{ }Wₜ = Mi(wᵢ)
    \hat{ }Wⱼ = transpose(Mⱼ)(\hat{ }Wₜ)
    Yj = Dj(Wj)
    \hat{ }yⱼ = Dⱼ(\hat{ }wⱼ)
    Lossd = lossd + ld(1,yⱼ) + ld(0,\hat{ }yⱼ)
  Update all D parameters to minimize lossd
```

FIG. 6 is a flow chart showing joint embedding method according to an embodiment of the present invention. An image embedding process 610 is used in combination with a word embedding process 650. The output of the image embedding process 610 is a 4096 dimensional image embedding 615. The output of the word embedding process a 256 dimensional word embedding 655.

We use convolutional neural networks to embed the images with the contextual information. Since the social data images can be in varying sizes, we convert them to 512×512 pixel images with their associated words and tags. We take RGB (color) images 620 into consideration at image embedding. We have 6 convolutional layers 622 and followed by 3 fully connected layers 624. Its 10th final layer 626 outputs 4096 image dimensions 615. In order to enrich the text with the information from the images, we combine the two embeddings (text and image) to a final joint embedding 660. The first 4096 dimensions 615 are from the image and the remaining 256 dimensions are from text embeddings 655. The reason for 256 dimensions in the text is due to our experimental evaluation on social data. It reveals that 256 dimensions is a good enough number to represent most of the social data (Instagram or twitter posts, a review on amazon etc). This social data usually contains short sentences and short words and is able to convert a full post into a 256 dimensional array. If the post is larger then we split that two multiple parts and embed each part separately. The word embedding takes text 660 as input and projects 662 these onto embeddings 664 in a word space.

We use XLM-Roberta for our name entity recognition transfer learning task. XLM-Roberta is a transformer-based language model released by Facebook AI team in November 2019. It is a quite large multi-lingual language model and trained on 2.5TB text data in about 100 different languages. The main improvement of XLM-Roberta is training on a rather large corpus and significant performance gain for a large variety of cross-lingual transfer tasks. Unlike other multilingual language models with a language specific tokenizer, XLM-Roberta uses a large shared sentence piece model for tokenization. Then based on the input ids, it's able to determine the correct language. Thus, it is convenient for our multilingual use case.

In the present disclosure, we sample a very large corpus from the data collected from social data. Then get it cleaned and all the concepts (e.g. product, ingredient, consumer needs, etc) labelled with the standard IOB tagging format. Then we fine tune the model. HugginFace's transformer python package and simple transformer which has scripts for many NLP tasks are used to train our model. First the original text data is tokenized into byte pairs by a sentence piece tokenizer. And converted to tensors and loaded tensors into a data loader. Then train the model over 3-8 epochs, at the end of every epoch, run a validation on the validation set and save the precision, recall and F1 score measurement also the best model. The best model saved will be packaged and deployed for future inference on the text data and discovering new unseen food related concepts.

Returning now to FIG. 4, in step 408, the training module 166 is executed by the processor 110 of the product concept assessment system 100 to train the market model 152.

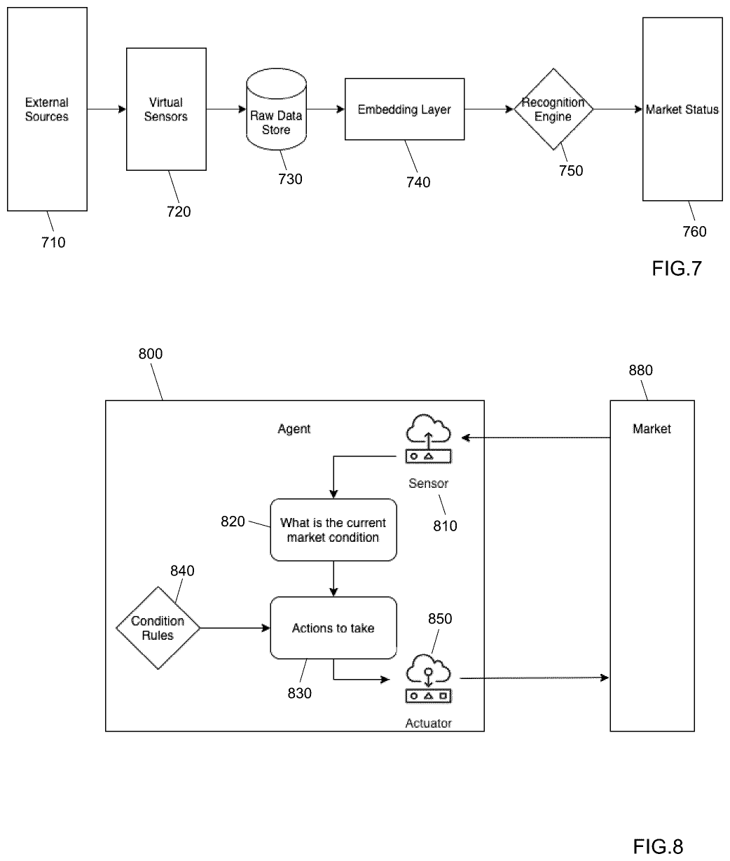

FIG. 7 is a flow chart showing training of a market model according to an embodiment of the present invention. As shown in FIG. 7, data is collected from external sources 710 using virtual sensors 720. The collected data raw data is stored in a data store 730. The embedding layer 630 is used to embed the data and it is then passed through the recognition engine 740 before being used to update the market status 750.

In some embodiments, the market model is updated for each candidate product concept using a plurality of agents to simulate interactions between consumers and interactions between consumers and influences on social media in response to the candidate product concept.

When designing systems that are complex, dynamic and stochastic in nature, simulation is generally recognized as one of the best design support technologies, and a valuable aid in the strategic and tactical decision-making process. Launching a new product and testing the market acceptance of this new product is such a complex problem and can be evaluated through a simulation at low cost relative to the actual launch and real-world testing which might cost millions of dollars. The purpose of simulation is either to better understand the operation of a target system, or to make predictions about a target system's performance. It can be viewed as an artificial white room which allows one to gain insight but also to test new theories and practices without disrupting the daily routine of the focal organization.

In the present disclosure a new process of using agents to simulate product concept testing and product concept ranking is introduced. An agent in this process is a unit that represents a real-world consumer. In order to simplify the behavior of the agent we only set minimal actions to be performed by agent as “accept product concept” (Yes vote) or “reject product concept” (No vote). An agent can only perform one and only one action in a given situation. In this simulation, the current action does not depend on the previous action taken by the same agent, and only be based on the current market condition perceived through the sensors. These virtual sensors act as receptors to acquire market information of trending consumer needs, trending ingredients, the growth rate of such trends, the geographical distribution of such trends, the alternative products and number of competitors.

FIG. 8 is shows updating of a market model by an agent according to an embodiment of the present invention. As shown in FIG. 8, the agent comprises a sensor 810 which acquires information from the market 880. Based on the sensed information, the agent determines the current market condition 820. Based on the determined market condition and stored condition rules, the agent determines actions to take 830. An actuator 850 updates the market 880 based on these actions.

A plurality of agents may be implemented by the agent simulation module 168 stored in the program storage 160 of the product concept assessment system 100 shown in FIG. 1.

An agent's action depends on multiple parameters which can be set at the start of the simulation. When the simulation is running, these parameters cannot be changed. In order to change the parameter values, a new simulation should be set up with new parameter values and we provide an easy comparison of simulation results of different simulations.

The following parameters can be set up at the start of simulation.

Agents: There are two types of agents in our proposed simulation. To mimic the real world, we introduce consumers and influencers as two types of agents. These are consumers and influencers.

Consumers are the general public in the market which makes a buying decision, communicating their emotions towards the product via social media or ecommerce platforms. A person may post a recipe on recipe databases or leave a comment/reply for such. These consumers are connected to other consumers and might influence the decision of another consumer to some extent (depending on friends/colleagues etc). The relationship cardinality (degree of connectivity) among the consumers are relatively low compared to influencers. This ranges from 10-6000 connections.

Influencers are special types of agents in our system where the relationship cardinality (degree of connectivity) is significantly higher. Which means many other consumers/influencers follow a particular influencer and a message from an influencer encourages the buying decision of their followers. Different influencers have a different cardinality which can range from 20K-2M.

Borrowing reproduction number (R number) from virus propagation, we implement the same for market simulation. The definition of R number determines how many times a consumer or influencer can contribute to a positive buying decision of their followers.

For example, if R number is 2 for a particular consumer, then that consumer influences 2 other consumers connected to him/her to have a positive buying decision. If R number is 50 for a particular influencer that means 50 followers of that influencer makes a positive buying decision on the product.

In our system we can set R number for consumers (a fixed R number) and R number for consumers (varying R number proportional to number of followers).

The distribution of consumer and influencer agents can be set up as a parameter which given p number of agents in simulations c percentage is set as consumers and remaining (100-c) or (i) number of agents are influencers. For the c number of agents the degree of connectivity ranges from 10-6000 and for agents the same number varies from 20000 to 2,000,000.

Consumers liking (or interest) to the product concept is associated with publishing a post and getting likes and comments to that post. Thus, we simulate this behavior through the R number associated with a particular agent. This interest can be one time, or for a duration of time (with time decay) or throughout the entire simulation duration. As these are factors (set up randomly) associated with the simulation the user can set these parameters at the beginning of the simulation.

### Thus:

1. One time—α percentage of all agents which are one time
2. Duration—β percentage of all agents which have interest for T duration with P number of posts. We emulate T via P number of posts.
3. The entire remainder of the simulation.

An example simulation algorithm is as follows:

| Simulation setup | | | |
|---|---|---|---|
| | 1. | Agents - % of distribution | |
| | | | a. Consumers |
| | | | b. Influencers |
| | 2. | Duration of the interest - % of distribution | |
| | | | a. One time (1) |
| | | | b. Period T (2) |
| | | | c. Continues (3) |
| | 3. | R number | |
| | | | a. R in the entire group |
| | | | b. R in individual agent |

Simulation Algorithm

| Initial Setup: | |
|---|---|
| | Agents = n |
| | Duration = t |
| | R number for group = r |
| | R number for agents = {rₐ₁,rₐ₂,...,rₐₘ} |
| | M = [{I}},{T}]; Market information |

Input
P = {P₁,P₂,...,Pₙ} where Pᵢ is a product concept.

Preprocessing:

For every Pᵢ in P
S_{Pi} = process_product_concepts(Pᵢ):
Ranks = Ordered({S_{P1},S_{P2},...,S_{Pn})
process_product_concepts(Pᵢ):
e_{Pi} = embeddings(Pᵢ)
{E_{Pi}} = NER(e_{Pi})
R_{Pi} = Relevance({E_{Pi}})
O_{Pi} = Originality({E_{Pi}})
Return Scoring(R_{Pi}, O_{Pi} )
Relevance({E_{Pi}}):
For every e in {E_{Pi}}:
If e in M and e is an Ingredient:
Rank_{I} <- {Rank_{I},ₑ}
If e in M and e is a Theme:
Rank_{T} <- {Rank_{T},ₑ}
Return {mean(Rank_{I}), mean(Rank_{T})}
Originality({E_{Pi}}):

Simulation Run:

| | Timer = 3 hrs (for 3 month) |
|---|---|
| | T_{d} = 1 seconds (for 2 days) |
| For each Pi in P: | |
| | e_{Pi} = embeddings(Pᵢ) |
| | {E_{Pi}} = NER(e_{Pi}) |
| | Select random set of agents known as Φ where Φ <<< n |
| | start the timer and set the expiry to 3 hrs |
| | Set the interval to 1 seconds |
| | For each Ai in Φ |
| | RepeatFlag = rand(1,2,3) |
| | For each e in {E_{Pi}} and if e is in M or T: -------- (Step x) |
| | GlobalEngagement of e = GlobalEngagement of e + rand(0,200) |
| | From connected Agents ε to Ai, |
| | Select r agents randomly from ε |
| | For each agent Aⱼ set the flag to “ON” |
| | Set sleep for 1 second |
| | If RepeatFlag = 1: |
| | End |
| | If RepeatFlag = 2 and timer < Tₚ : |
| | Repeat again from Step x |
| | If RepeatFlag = 3: |
| | Repeat again from Step x |
| | If RepeatFlag = 2 and timer > Tₚ : |
| | End |
| | For each Aⱼ not in Φ and Aⱼ Flag “ON” |
| | RepeatFlag = rand(1,2,3) |
| | For each e in {E_{Pi}} and if e is in M or T: -------- (Step y) |
| | GlobalEngagement of e = GlobalEngagement of e + rand(0,200) |
| | From connected Agents ε to Aⱼ, |
| | Select r agents randomly from ε |
| | For each agent Aₖ set the flag to “ON” |
| | Set sleep for 1 second |
| | If RepeatFlag = 1: |
| | End |
| | If RepeatFlag = 2 and timer < Tₚ : |
| | Repeat again from Step y |
| | If RepeatFlag = 3: |
| | Repeat again from Step y |
| | If RepeatFlag = 2 and timer > Tₚ : |

End

Whilst the foregoing description has described exemplary embodiments, it will be understood by those skilled in the art that many variations of the embodiments can be made within the scope and spirit of the present invention.

1. A machine learning method for assessing product concepts, the method comprising:
receiving a plurality of candidate product concepts, each candidate product concept comprising a natural language name and description of a candidate product;
for each candidate product concept, extracting product ingredient data and product theme data, the product ingredient data indicating at least one product ingredient and the product theme data indicating at least one product theme;
for each candidate product concept, determining a relevance metric using a market model, the market model comprising a machine learning model trained to provide relevance scores for product themes and product ingredients, and determining an originality metric using a cluster model;
ranking the candidate product concepts in a ranking order according to the respective relevance metrics and originality metrics; and
generating a ranked list of candidate product concepts according to the ranking order.

2. A machine learning method according to claim 1, wherein extracting product ingredient data and product theme data, comprises using an embedding model and a recognition model.

3. A machine learning method according to claim 2, wherein the embedding model comprises mappings from a plurality of languages.

4. A machine learning method according to claim 1, wherein determining a relevance metric using a market model for each candidate product concept comprises:
simulating a consumer response to each respective candidate product concept using a plurality of simulated agents which are configured to update the market model and thereby obtain a respective simulated market model for the respective candidate product concept, and determining the respective relevance metric from the respective simulated market model for the candidate product concept.

5. A machine learning method according to claim 4, wherein simulating the consumer response to the candidate product using a plurality of simulated agents comprises simulating interactions between simulated agents over a plurality of simulation cycles, wherein simulated agents of the plurality of simulated agents are configured to be connected to other connected simulated agents of the plurality of simulated agents and thereby influence behavior of the connected simulated agents.

6. A method according to claim 5, wherein a first simulated agent of the plurality of simulated agents has a higher number of connections than a second simulated agent of the plurality of simulated agents.

7. A method of training a market model to provide relevance scores for product themes and product ingredients, the method comprising:
monitoring social network posts to collect data;
extracting product ingredient data and product theme data from the collected data;
training a recognition engine using the collected data to recognize ingredients and product themes from the collected data; and
training a market model based on the ingredients and the product themes.

8. A method of training a market model according to claim 7, wherein monitoring social network posts to collect data comprises implementing a plurality of market sensors.

9. A method of training a market model according to claim 7, wherein the collected data comprises text data and image data and wherein extracting product ingredient and product theme data from the collected data comprises implementing a joint text and image embedding layer.

10. A method of training according to claim 7, wherein extracting product ingredient and product theme data from the collected data comprises implementing a multi-lingual embedding layer.

11. A computer readable medium storing processor executable instructions which when executed on a processor cause the processor to carry out a method according to claim 1.

12. A machine learning system for assessing product concepts, the system comprising:
a processor;
a data storage device storing: a market model comprising a machine learning model trained to provide relevance scores for product themes and product ingredients; and a cluster model; and
a program storage device storing computer program instructions operable to cause the processor to:
receive a plurality of candidate product concepts, each candidate product concept comprising a natural language name and description of a candidate product;
for each candidate product concept, extract product ingredient data and product theme data, the product ingredient data indicating at least one product ingredient and the product theme data indicating at least one product theme,
for each candidate product concept, determining a relevance metric using the market model, and determine an originality metric using the cluster model;
rank the candidate product concepts in a ranking order according to the respective relevance metrics and originality metrics; and
generate a ranked list of candidate product concepts according to the ranking order

13. A machine learning system according to claim 12, wherein the program storage device further stores computer program instructions operable to cause the processor to extract product ingredient data and product theme data using an embedding model and a recognition model.

14. A machine learning system according to claim 13, wherein the embedding model comprises mappings from a plurality of languages.

15. A machine learning system according to claim 11, wherein the program storage device further stores computer program instructions operable to cause the processor to determine a relevance metric using a market model for each candidate product concept by simulating a consumer response to each respective candidate product concept using a plurality of simulated agents which are configured to update the market model and thereby obtain a respective simulated market model for the respective candidate product concept, and determining the respective relevance metric from the respective simulated market model for the candidate product concept.

16. A machine learning system according to claim 15, wherein the program storage device further stores computer program instructions operable to cause the processor to simulate the consumer response to the candidate product using a plurality of simulated agents by simulating interactions between simulated agents over a plurality of simulation cycles, wherein simulated agents of the plurality of simulated agents are configured to be connected to other connected simulated agents of the plurality of simulated agents and thereby influence behavior of the connected simulated agents.

17. A machine learning system according to claim 11, wherein the program storage device further stores computer program instructions operable to cause the processor to train the market model to provide relevance scores for product themes and product ingredients by:
monitoring social network posts to collect data;
extracting product ingredient data and product theme data from the collected data;
training a recognition engine using the collected data to recognize ingredients and product themes from the collected data; and
training a market model based on the ingredients and the product themes.

18. A machine learning system according to claim 17, wherein the program storage device further stores computer program instructions operable to cause the processor to monitor social network posts to collect data by implementing a plurality of market sensors.

19. A machine learning system according to claim 17, wherein the collected data comprises text data and image data and wherein the program storage device further stores computer program instructions operable to cause the processor to extract product ingredient and product theme data from the collected data by implementing a joint text and image embedding layer.

20. A machine learning system according to claim 17, wherein the program storage device further stores computer program instructions operable to cause the processor to extract product ingredient and product theme data from the collected data by implementing a multi-lingual embedding layer.
